(19) United States
(12) Patent Application Publication
(10) Pub. No.: US 2018/0322431 A1
(43) Pub. Date: Nov. 8, 2018

(54) PREDICTING REALISTIC TIME OF ARRIVAL FOR QUEUE PRIORITY ADJUSTMENT

(71) Applicant: Walmart Apollo, LLC, Bentonville, AR (US)

(72) Inventor: Travis Folck, Rogers, AR (US)

(21) Appl. No.: 15/963,143

(22) Filed: Apr. 26, 2018

Related U.S. Application Data
(60) Provisional application No. 62/502,161, filed on May 5, 2017.

(51) Int. Cl. G06Q 10/06; G06Q 30/06; G01S 19/51; G01C 21/34

(52) U.S. Cl. CPC G06Q 10/06316; G06Q 30/0601; G06Q 10/0633; G01C 21/3407; G01S 19/51

(57) ABSTRACT

A queue prioritization system and method for predicting a realistic time of arrival for performing a queue priority adjustment is provided. The method includes the steps of determining an estimated initial arrival time of a first user and a second user to a destination, the estimated initial arrival time being used to establish a queue priority, tracking a current location and predicting a route to be taken to arrive at the destination from the current location, detecting a schedule-altering event of the first user by analyzing: (i) the predicted route of the first user, or (ii) a current state of a vehicle, and reprioritizing the queue priority database, in response to calculating an updated queue priority of the first user that is lower than the queue priority of the second user, based on the detection of the schedule-altering event of the first user.

### CROSS REFERENCE TO RELATED APPLICATION[S]

This application claims the benefit of U.S. Provisional application No. 62/502,161, filed May 5, 2017, the contents of which are incorporated herein in their entirety.

### TECHNICAL FIELD

The present invention relates to systems and methods of predicting a realistic time of arrival, and more specifically to embodiments of a queue prioritization system for performing a queue priority adjustment based on a realistic time of arrival.

### BACKGROUND

Retailers offer customers an option to purchase items online and then pick up the purchased items at a retail location selected by the customer. A queue priority is maintained so that the purchased items are ready for the customer when the customer arrives at the retail location. Similarly, delivery systems must coordinate receiving area locations associated with the retail location, depending on the timing of arrival of delivery trucks.

### SUMMARY

An embodiment of the present invention relates to a method, and associated computer system and computer program product, for predicting a realistic time of arrival for performing a queue priority adjustment. A processor of a computing system determines an estimated initial arrival time of a first user and a second user to a destination, the estimated initial arrival time being used to establish a queue priority of the first user and a queue priority of the second user, in a queue priority database, the queue priority of the first user being higher than the queue priority of the second user. A current location of the first user and a current location of the second user is tracked during transit to the destination. A route to be taken to arrive at the destination from the current location of the first user and the current location of the second user, respectively, is predicted. A schedule-altering event of the first user is detected by analyzing: (i) the predicted route of the first user, or (ii) a current state of a vehicle. The queue priority database is reprioritized, in response to calculating an updated queue priority of the first user that is lower than the queue priority of the second user, based on the detection of the schedule-altering event of the first user.

### BRIEF DESCRIPTION OF THE DRAWINGS

FIG. 1 depicts a block diagram of a queue prioritization system, in accordance with embodiments of the present invention.

FIG. 2 depicts a schematic view of a first user and a second user having a projected initial arrival time, in accordance with embodiments of the present invention.

FIG. 3 depicts a schematic view of a predicted route and estimated time of arrival of the first user from a first current location, in accordance with embodiments of the present invention.

FIG. 4 depicts a schematic view of a predicted route and estimated time of arrival of the first user from a second current location, in accordance with embodiments of the present invention.

FIG. 5 depicts a schematic view of a predicted route and estimated time of arrival of the first user from a third current location, in accordance with embodiments of the present invention.

FIG. 6 depicts a schematic view of a new predicted route and estimated time of arrival of the first user from a fourth current location, in accordance with embodiments of the present invention.

FIG. 7 depicts a schematic view of a schedule-altering event of the first user, in accordance with embodiments of the present invention.

FIG. 8 depicts a flow chart of a method for predicting a realistic time of arrival for performing a queue priority adjustment, in accordance with embodiments of the present invention.

FIG. 9 depicts a first flow chart of a step of the method for predicting a realistic time of arrival for performing a queue priority adjustment of FIG. 8, in accordance with embodiments of the present invention.

FIG. 10 depicts a second flow chart of a step of the method for predicting a realistic time of arrival for performing a queue priority adjustment of FIG. 8, in accordance with embodiments of the present invention.

FIG. 11 illustrates a block diagram of a computer system for the queue prioritization system of FIGS. 1-7, capable of implementing methods for predicting a realistic time of arrival for performing a queue priority adjustment of FIGS. 8-10, in accordance with embodiments of the present invention.

### DETAILED DESCRIPTION

In-store pickup is a feature offered by some retailers, which allows a user to shop for goods online and pick the goods up at a store selected by the user. By shopping for the goods online, the user can avoid walking through the store aisles to locate the particular goods, load the goods in a cart, and wait in a general checkout lane. In some embodiments, the retailer must retrieve the goods purchased and/or selected by the user prior to the user arriving to the store. Each user purchase order may be kept in a queue database, so that the retailer knows an order with which to fulfill each of the user purchase orders. The goods may be retrieved in response to a predicted time of arrival based on user input information on the purchase order (e.g. user selects a predefined pickup time) or may be automatically generated based on a complexity of the purchase order (e.g. time needed to prepare the goods). However, this static information used to determine the time of arrival of a user is unreliable and may change due to various user and environmental circumstances. The unrealistic arrival times can cause problems with the queue priority database, as well as clutter customer checkout areas and/or the salesfloor with retrieved goods not yet picked up by the user.

Likewise, delivery services to a retailer may rely on estimated times of arrival for organizing and coordinating delivery and receiving operations. Initial times of arrival may be estimated by knowing the distance to be traveled and an average speed, or current speed of the truck. Unfortunately, the initially estimated times of arrival cause problems with the queue priority database.

Thus, there is a need for predicting a realistic time of arrival for performing a queue priority adjustment.

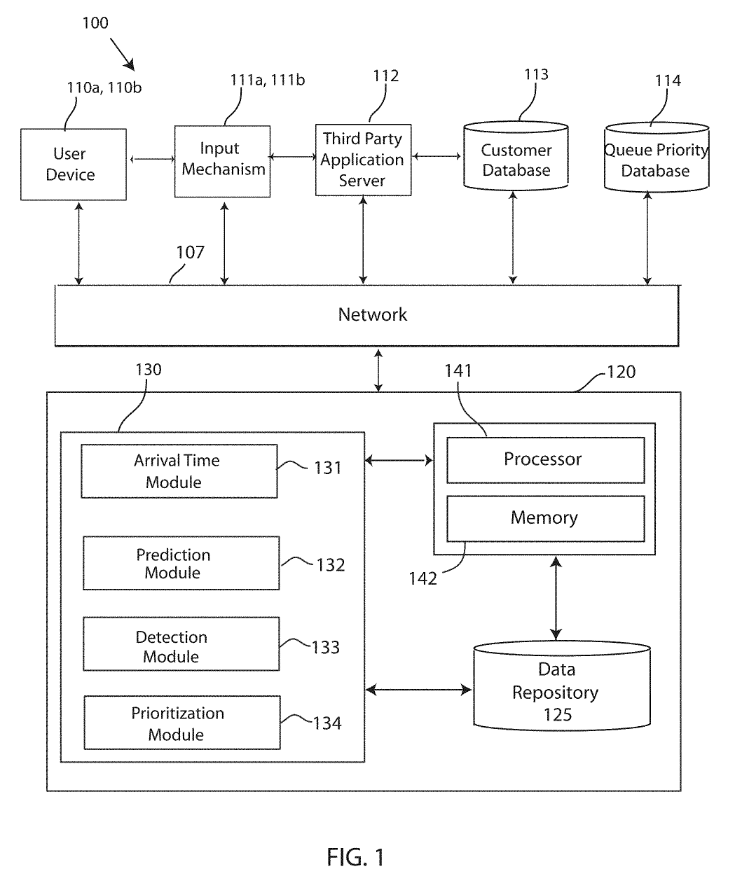

Referring to the drawings, FIG. 1 depicts a block diagram of queue prioritization system 100, in accordance with embodiments of the present invention. Embodiments of the queue prioritization system 100 may be a system for predicting a realistic time of arrival for performing a queue priority adjustment. Embodiments of the queue prioritization system 100 may be useful for retailers, parcel delivery entities, public or private transportation centers, fulfillment warehouses, or any entity that may need to adjust a priority in a database, based on a realistic arrival time. Embodiments of the queue prioritization system 100 may include a computing system 120. Embodiments of the computing system 120 may be a computer system, a computer, a server, one or more servers, a cloud computing device, a hardware device, a remote server, and the like.

Furthermore, embodiments of queue prioritization system 100 may include a user device 110a, 110b, an input mechanism 111a, 111b, a third party application server(s) 112, a customer database 113, and a queue priority database 114, communicatively coupled to a computing system 120 of the queue prioritization system 100 over a network 107. A network 107 may be the cloud. Further embodiments of network 107 may refer to a group of two or more computer systems linked together. Network 107 may be any type of computer network known by individuals skilled in the art. Examples of computer networks 107 may include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA network or a mobile communications data network. The architecture of the computer network 107 may be a peer-to-peer network in some embodiments, wherein in other embodiments, the network 107 may be organized as a client/server architecture.

In some embodiments, the network 107 may further comprise, in addition to the computing system 120, a connection to one or more network-accessible knowledge bases containing information of the user, network repositories or other systems, such as the Internet of Things (IOT) connected to the network 107 that may be considered nodes of the network 107. In some embodiments, where the computing system 120 or network repositories allocate resources to be used by the other nodes of the network 107, the computing system 120 and network repository may be referred to as servers.

The network repository (not shown) may be a data collection area on the network 107 which may back up and save all the data transmitted back and forth between the nodes of the network 107. For example, the network repository may be a data center saving and cataloging user orders, user traffic patterns to and from a destination, an average time to the destination, and the like, to generate both historical and predictive reports regarding a particular user or a user's routes to and from a destination. In some embodiments, a data collection center housing the network repository may include an analytic module capable of analyzing each piece of data being stored by the network repository. Further, the computing system 120 may be integrated with or as a part of the data collection center housing the network repository. In some alternative embodiments, the network repository may be a local repository that is connected to the computing system 120.

Further, embodiments of the computing system 120 may be equipped with a memory device 142 which may store the user selections, and a processor 141 for implementing the tasks associated with the queue prioritization system 100. In some embodiments, a prioritization application 130 may be loaded in the memory 142 of the computing system 120. The computing system 120 may further include an operating system, which can be a computer program for controlling an operation of the computing system 120, wherein applications loaded onto the computing system 120 may run on top of the operating system to provide various functions. Furthermore, embodiments of computing system 120 may include the prioritization application 130. Embodiments of the prioritization application 130 may be an interface, an application, a program, a module, or a combination of modules. In an exemplary embodiment, the prioritization application 130 may be a software application running on one or more back end servers, servicing multiple computing devices.

The queue prioritization application 130 of the computing system 120 may include an arrival time module 131, a prediction module 132, a detection module 133, and a prioritization module 134. A “module” may refer to a hardware-based module, software-based module or a module may be a combination of hardware and software. Embodiments of hardware-based modules may include self-contained components such as chipsets, specialized circuitry and one or more memory devices, while a software-based module may be part of a program code or linked to the program code containing specific programmed instructions, which may be loaded in the memory device of the computing system 120. A module (whether hardware, software, or a combination thereof) may be designed to implement or execute one or more particular functions or routines.

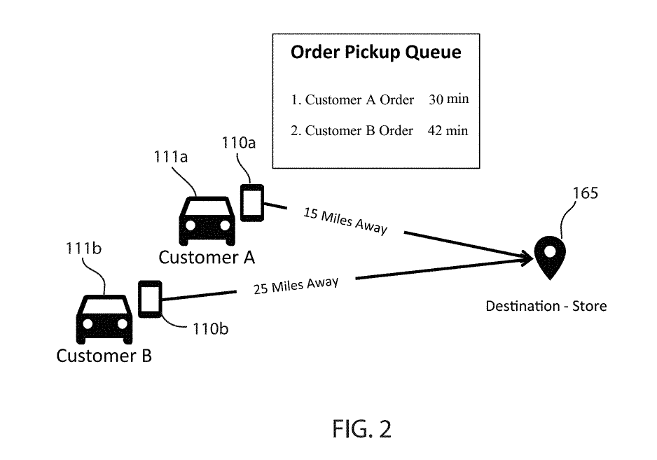

Embodiments of the arrival time module 131 may include one or more components of hardware and/or software program code for determining an estimated initial arrival time of a first user and a second user to a destination. The estimated initial arrival time may be used to establish a queue priority of the first user and a queue priority of the second user in the queue priority database 114. FIG. 2 depicts a schematic view of a first user and a second user having a projected initial arrival time, in accordance with embodiments of the present invention. In FIG. 2, the queue priority of the first user (e.g. Customer A) is higher than the queue priority of the second user (e.g. Customer B) because an estimated time to arrival to a destination 165 for the first user is less than an estimated time to arrival to the destination 165 of the second user. In other words, the first user may arrive at the destination before the second user, which means the destination 165 (e.g. retail location) may plan to process an order associated with the first user prior to processing an order associated with the second user, wherein a starting time of the processing of the order depends on the estimated arrival time. Embodiments of the destination 165 may include a store, a retail location, a physical building, a pickup location, a delivery destination, a receiving area, a shipyard, a fulfillment warehouse, a home, a business, and the like.

Embodiments of the first user may be associated with a user device 110a and an input mechanism 111a. Embodiments of the user device 110a may be a mobile computing device, a cell phone, a smart phone, a tablet computing device, a computer, a laptop, a smart watch, a wearable sensor, or other computing device capable of communicating with the computing system 120 over network 107. Embodiments of the user device 110a may be a smartphone of the first user, capable of providing GPS information to the computing system 120. Embodiments of the user device 110a may also transmit other signals, receive communications, and deliver information to the computing system 120. Moreover, embodiments of the input mechanism 111a may be one or more sources of data for the computing system 120. For instance, embodiments of the input mechanism 111a may be a sensor, a wearable sensor worn by the first user, a peripheral device communicatively coupled to the computing system 120, a microphone positioned within an environment shared by the first user, a camera positioned within the environment shared by the first user, a vehicle onboard computing system, a node of a vehicle-to-vehicle communication network, a vehicle sensor, a vehicle transmitter, a drone computer, a drone sensor, a drone transmitter, and the like. In an exemplary embodiment, the input mechanism 111a may be vehicle computer or sensor of a vehicle being driven or otherwise operated by the first user.

Similarly, embodiments of the second user may be associated with a user device 110b and an input mechanism 111b. Embodiments of the user device 110b may be a mobile computing device, a cell phone, a smart phone, a tablet computing device, a computer, a laptop, a smart watch, a wearable sensor, or other computing device capable of communicating with the computing system 120 over network 107. Embodiments of the user device 110b may be a smartphone of the second user, capable of providing GPS information to the computing system 120. Embodiments of the user device 110b may also transmit other signals, receive communications, and deliver information to the computing system 120. Moreover, embodiments of the input mechanism 111b may be one or more sources of data for the computing system 120. For instance, embodiments of the input mechanism 111b may be a sensor, a wearable sensor worn by the second user, a peripheral device communicatively coupled to the computing system 120, a microphone positioned within an environment shared by the second user, a camera positioned within the environment shared by the second user, a vehicle onboard computing system, a node of a vehicle-to-vehicle communication network, a vehicle sensor, a vehicle transmitter, a drone computer, a drone sensor, a drone transmitter, and the like. In an exemplary embodiment, the input mechanism 111b may be vehicle computer or sensor of a vehicle being driven or otherwise operated by the second user. Further, embodiments of the queue prioritization system 100 may include numerous user devices and input mechanisms associated with numerous users.

Referring back to FIG. 1, embodiments of the arrival time module 131 may determine an initial estimated arrival time of the first user and the second user. Determining the initial estimated time of arrival may be performed in response to receiving a customer pick up order, receiving a confirmation of user departure to the destination 165, prompting the user to depart for the destination 165, receiving a delivery truck schedule, and the like. Embodiments of the arrival time module 131 may determine the estimated initial arrival time of the first user and the second user using information input by the user, automatically generated by a pickup ordering system coupled to the computing system 120, data received from the first and second user devices 110a, 110b and the first and second input mechanisms 111a, 111b, and data retrievable from one or more databases, such as a customer database 113. For example, the arrival time module 131 may receive a customer pickup order containing information and specifics of an order. The information of the order may be used to determine a complexity of the order. The complexity of the order may be affected by a number of items, a weight of the items, a location of items to be retrieved from shelves/storage, a climate condition requirement, and the like. The complexity of the order may determine how much time the destination representatives will need to properly prepare and process the order. In addition to using information and specifics of the user order, the arrival time module 131 may obtain a current GPS location information of the first user and the second user from the user device 110a, 110b of the first user and the second user. For example, users may use a software application associated with a retailer on a mobile device to shop online for items and select a pickup option, wherein the software application may cause the mobile device to initiate a transmission of location information, such as GPS coordinates to the user's current location. In an exemplary embodiment, user device 110a, 110b may determine that the user is at a known location, such as a home of the user, and communicate that the user is located at home to the computing system 120. Embodiments of the arrival time module 131 may access or otherwise query the customer database 113 to determine home address information and other relevant data about the user that may be helpful to calculating an estimated time of arrival, such as distance from the user's home to the store. Further, embodiments of the arrival time module 131 may review historical user data, including a historical path(s) taken by the first user and the second user to the destination. The historical user data may be stored in or otherwise available from customer database 113. Embodiments of customer database 113 may be a database, a storage medium, a hardware storage device, and the like, coupled to the computing system 120; the customer database 113 may also be coupled to servers servicing mobile application requests from mobile devices. The customer database 113 may include information relating to traffic patterns of the user over time, such as trips back and forth from a home location to the destination 165. The historical traffic patterns may be data voluntarily provided by the users. The traffic pattern data may be originated by the user device 110a, 110b or the input mechanisms 111a, 111b.

Accordingly, embodiments of the arrival time module 131 may evaluate the complexity of the customer pickup order or a delivery schedule to determine an earliest store pick-up time or a delivery/receiving dock availability, and compare the earliest store pick-up time or the delivery/receiving area dock availability, the current GPS location of the first user and the second user, and previous path(s) taken by the first user and the second user to the destination 165 based on the historical data, to determine the estimated initial arrival time. Embodiments of the arrival time module 131 may determine an initial estimated time of arrival in response to receiving the completed customer order or receiving a delivery schedule. For instance, embodiments of the arrival time module 131 may prompt the first user and the second user to depart for the destination 165. The prompting may include sending a text message, automated call, email, notification, or other electronic communication to the user device 110a, 110b or a vehicle computing system 111a, 111b, or a digital/virtual assistant or smart speaker, associated with the user. For instance, embodiments of the arrival time module 131 may send a communication to an application server of a retailer's application loaded onto the user's mobile device, wherein a notification, such as a “leave now” badge is displayed on the user's mobile device display, which may prompt the user to depart for the destination 165. In another embodiment, the arrival time module 131 may send a communication to an application server of a retailer's application loaded onto the user's digital assistant, wherein a notification, voice alert, instructions, etc. may be delivered to the user from the digital assistant, which may prompt the user to depart for the destination 165. In an exemplary embodiment, prompting the user to depart for the destination 165 may be considered a notification that if the user leaves the user's current location now, within a predetermined amount of time, or any time after the notification is sent to the user, the user's order may be ready for pickup. Moreover, the arrival time module 131 may determine an initial estimated time of arrival in response to prompting the first user and the second user to depart for the destination. For instance, the arrival time module 131 may prompt the user to depart for the destination 165 after analyzing the complexity of the order, historical data regarding how long the user takes to arrive at the store based on previous trips, and current location information, and then calculate the initial estimated time of arrival of the user. Further, the arrival time module 131 may determine the initial estimated time of arrival of the user in response to receiving confirmation from the first user and/or the second user that the first user and/or the second user have departed for the destination 165. The confirmation may be a communication sent from the user device 110a, 110b by the user (e.g. user clicks a link from a text message or email sent from the computing system 120) or may be a communication sent from a digital assistant or smart speaker in response to a user's voice command to the digital assistant to indicate that the user intends to leave the user's current destination. A combination of verbal acknowledgement and change in mobile device location/rate of speed can be used to confirm departure. Confirmation may also be supplied by the user through an installed application on the user's mobile device, which may present an alert on the user's mobile device, such as “leaving now” button, and when activated (e.g. button pressed), the installed application sends an appropriate communication to the computing system 120. Further, in response to receiving the communication from the user's mobile device (i.e. “leaving now” button pressed), the computing system 120 may wait to confirm the user has departed for the destination 165 until the computing system 120 detects a movement of the user along a path to the destination 165. Alternatively, or in addition to, the confirmation may be provided by new GPS data of the user's location changing and following a historical path(s) to the destination 165.

Embodiments of the computing system 120 may further include a prediction module 132. Embodiments of the prediction module 132 may include one or more components of hardware and/or software program code for predicting a route to be taken by the first user and/or the second user to arrive at the destination 165 from a current location of the first user and/or second user. For example, the prediction module 132 may access or otherwise query the customer database 113 to analyze the user's historical traffic patterns to predict a route that the user will take to the destination 165. If a user has consistently taken a particular route from a home location to the destination, then the prediction module 132 may predict that the user will again take the particular route to the destination. Based on a frequency the user has taken a particular route to the destination, the stronger a likelihood that the user's route will be stored in the customer database 113, and that the user will indeed take that route. Artificial intelligence and/or machine learning may also be applied to learn the user's driving habits to determine the most likely route (e.g. based on historic traffic patterns, weather data, current traffic data, user's preferred routes at a particular time of day, etc.) if the user deviates from the historic path. For example, machine learning may determine that the user never takes the highway, and detects that a side road that the user normally takes is under construction and determines the likelihood of which alternative path the user will take. The prediction module 132 may leverage artificial intelligence to learn the user's driving habits. For example, the prediction module 132 may gather and analyze data regarding a preferred speed that the user typically drives, a preferred type of road (e.g. highway, side road, etc.) that the user likes to drive on, and how user will react in certain conditions. For instance, if there is a traffic jam, the user may try to take an alternative path or may wait in the traffic jam, or when it is raining/snowing, will the user always go 20 miles per hour slower or will the user not drive at all.

The prediction module 132 may track the current location of the user during transit to confirm the accuracy of the prediction. For example, tracking the current location of the user during transit may provide a real-time update of the predicted route of the user to the destination 165. Tracking the current location of the user may be performed by periodically or continuously communicating with the user device 110a, 110b and/or the input means 111a, 111b, such as a vehicle computing system.

Moreover, the prediction module 132 may consult or otherwise communicate with a third party application server 112, such as a map application server or a directions application server to obtain or otherwise learn a suggested or “best” route for the user to take to the destination 165. For instance, the prediction module 132 may request directions from the third party application server 112 based on the tracked current location of the user, to predict or otherwise determine the route the user is most likely to take to the destination 165. The information/data received from the third party application server(s) may be compared and/or combined with the historical traffic patterns of the user for analysis by the prediction module 132. In an exemplary embodiment, predicting the route of the first user may include analyzing the current location of the user, current traffic data, construction data, historical routes to the destination taken by the first user, map data, and/or a combination thereof.

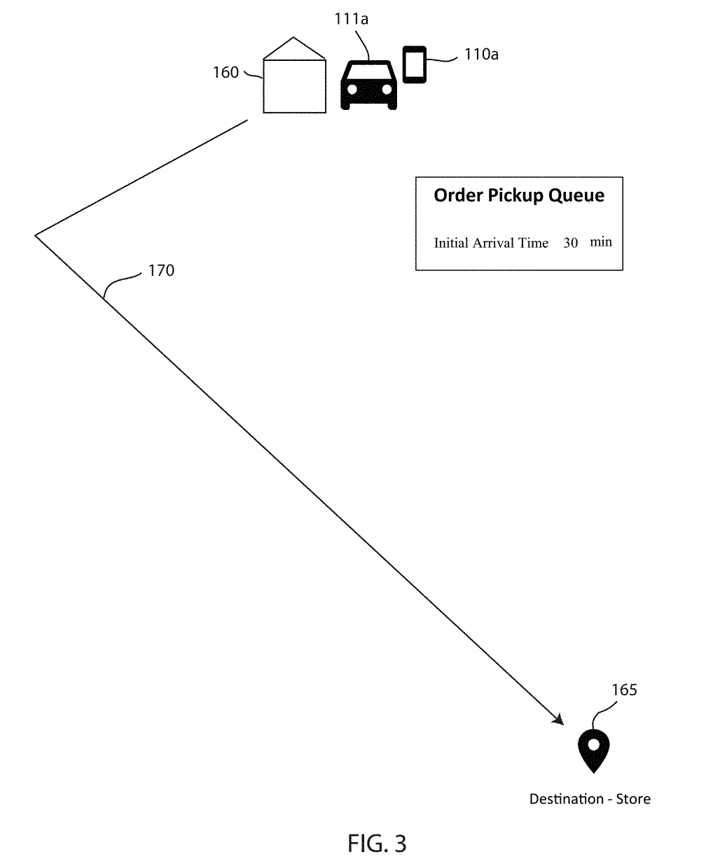

FIG. 3 depicts a schematic view of a predicted route 170 and estimated time of arrival of the first user from a first current location, in accordance with embodiments of the present invention. In FIG. 3, the current location is determined to be a home location 160 of the user (e.g. first user or Customer A). Embodiments of the arrival time module 131 have determined that the initial estimated arrival time for the first user is 30 minutes, and the prediction module 132 has predicted or otherwise determined that the most likely route the user will take to get to the destination 165, is predicted route 170. The estimated initial arrival time of 30 minutes for the first user is less than the estimated initial arrival time of the second user, which is 42 minutes, as shown in FIG. 2. Accordingly, the queue priority of the first user at this point may be higher than the queue priority of the second user.

Referring again to FIG. 1, embodiments of the computing system 120 may further include a detection module 133. Embodiments of the detection module 133 may include one or more components of hardware and/or software program code for detecting a schedule-altering event of the first user, which may prompt an adjustment of the queue priority in the queue priority database 114. For example, embodiments of the detection module 133 may detect, determine, identify, predict, etc. a schedule-altering event that is occurring to the first user or may occur to the first user. Embodiments of the schedule-altering event may be at least one of: a delay, a traffic jam, a traffic accident, a vehicle failure, a weather occurrence, a road closure, construction, police presence, an intervening stop by the first user, a wrong turn of the user, an alternative route taken by the user, a predicted traffic delay of the first user, a predicted weather delay of the first user, and/or a combination thereof. A detection of one or more schedule-altering events may affect an arrival time of the first user, such that the estimated arrival time is now later than the estimated arrival time of the second user, as described using exemplary embodiments below.

Embodiments of the detection module 133 may detect the schedule-altering event by analyzing the predicted route of the first user, and/or a current state of a vehicle. For example, the detection module 133 may analyze the predicted route 170 to determine, identify, etc., a schedule-altering event that may exist if the user follows the predicted route 170. The detection module 133 may communicate with the user device 110a, the input mechanism 111a, such as a car or delivery truck, one or more third party application servers 112, and potentially the customer database 113 to detect and/or predict a schedule-altering event. For instance, the detecting of the schedule-altering event includes receiving data from a plurality of data sources, which may include a current GPS location of the user received from a mobile device of the user, a real-time traffic data received from the mobile device of the user, a real-time traffic data received from a third party application server 112, a weather data received from the mobile device of the user, a weather data retrieved from a third party application server 112, a weather data and/or traffic data received from the user vehicle's computer, a historical traffic pattern information of the user (e.g. from the customer database 113), historical patterns from other users (e.g. other users having a home in a same geographical region, other users' traffic patterns used to determine a popular path to the destination), a sensor data received from one or more sensors associated with the user (e.g. wearable device), a vehicle and traffic information received from a vehicle-to-vehicle communication network, sensor data from a user's vehicle computing system, (e.g. vehicle sensors sensing road conditions, braking and acceleration data), and a combination thereof.

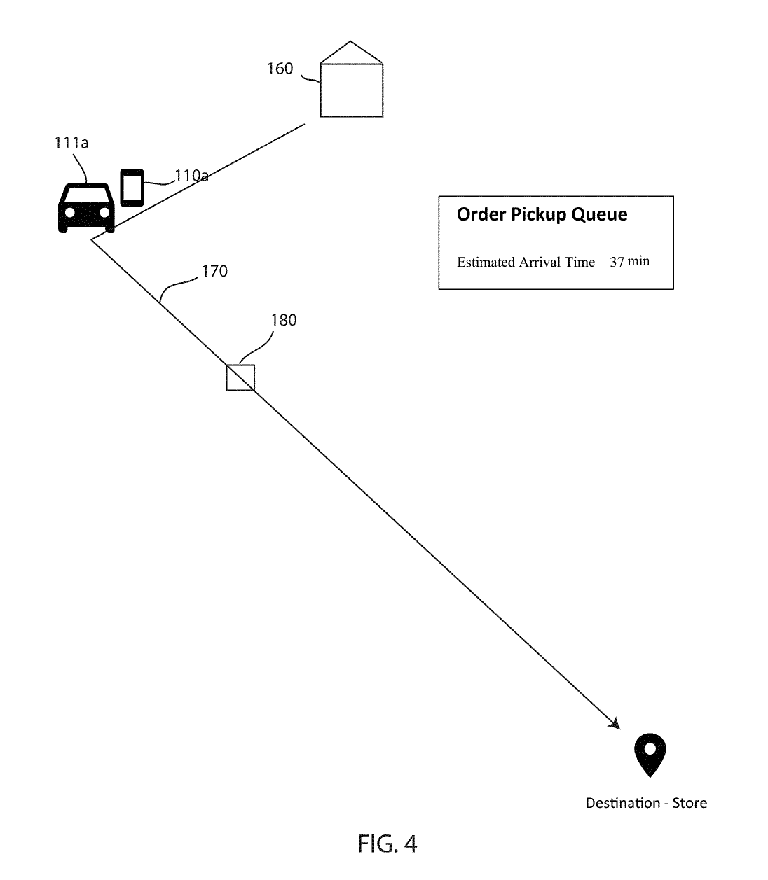

FIG. 4 depicts a schematic view of a predicted route 170 and estimated time of arrival of the first user from a second current destination, in accordance with embodiments of the present invention. In FIG. 4, the arrival time module 131 has determined that the current estimated arrival time for the first user is 37 minutes, and the prediction module 132 has predicted or otherwise determined that the most likely route the user will take to get to the destination 165, is predicted route 170. As the first user is in transit (i.e. has departed from a home location or initial location), the detection module 133 has detected, predicted, or otherwise identified a schedule-altering event 180 along the predicted route 170. For example, the detection module 133 has detected a traffic jam along the predicted route 170, which the first user will encounter if the first user continues along the predicted route 170. The schedule-altering event 180 (e.g. traffic jam) may have been detected by the detection module 133 via receiving, retrieving, or otherwise obtaining information/data from one or more data sources, such as a traffic application server 112, a vehicle-to-vehicle communication network transmitted by the input mechanism 111a associated with the first user, such as a vehicle, a navigation application server 112, and/or other users' mobile devices connected to the computing system 120 that may be reporting real-time GPS information while located in the traffic jam ahead in the predicted route 170. Thus, embodiments of the detection module 133 may communicate with third party application servers 112 and other data sources to detect a schedule-altering event 180 along the predicted route 170.

In response to the detection of the schedule-altering event 180 along a predicted route 170 of the first user, the initial estimated arrival time of the first user may be updated to a current estimated arrival time. For instance, the computing devices associated with the destination 165 may receive updates from the computing system 120 to alert the representatives, associates, employees, etc. of the destination 165 of the new estimated arrival time of the first user. In some embodiments, the newly updated estimated arrival time may still be sooner than a current estimated arrival time of the second user, and thus no queue priority adjustment is needed. In other embodiments, the newly updated estimated arrival time may now be later than the current estimated arrival time of the second user, wherein a queue priority adjustment may be performed. Further, artificial intelligence and machine learning can be used to determine of the user will stay on the route, regardless of the schedule-altering event, or will deviate to an alternate path.

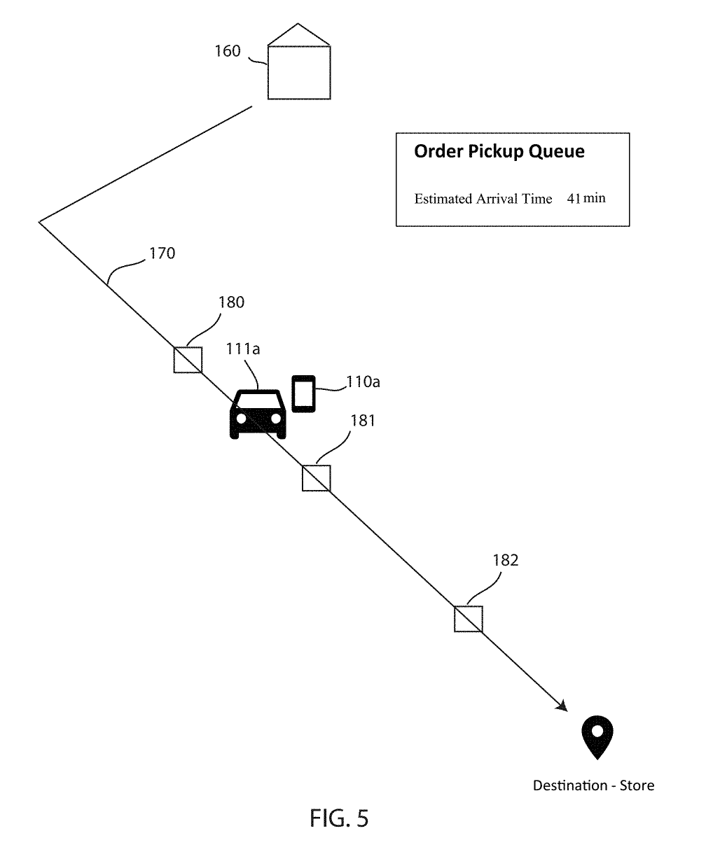

FIG. 5 depicts a schematic view of a predicted route 170 and estimated time of arrival of the first user from a third current location, in accordance with embodiments of the present invention. In FIG. 5, the arrival time module 131 has determined that the current estimated arrival time for the first user is now 41 minutes, and the prediction module 132 has predicted or otherwise determined that the most likely route the user will take to get to the destination 165, is predicted route 170. As the first user is in transit (i.e. has departed from a home location or initial location and continued beyond the first schedule-altering event 180), the detection module 133 has detected, predicted, or otherwise identified additional schedule-altering events 181, 182 along the predicted route 170. For example, the detection module 133 has detected heavy traffic delays due to a traffic accident (e.g. schedule-altering event 181) along the predicted route 170, and that snow has started falling along the predicted route 170, both of which the first user will encounter if the first user continues along the predicted route 170. The schedule-altering event 181 (e.g. traffic delays due to an accident) may have been detected by the detection module 133 via receiving, retrieving, or otherwise obtaining information/data from one or more data sources, such as a traffic application server 112, a police scanner network, a vehicle-to-vehicle communication network transmitted by the input mechanism 111a associated with the first user, such as a vehicle, a navigation application server 112, and/or other users' mobile devices connected to the computing system 120 that may be reporting real-time GPS information while located in the traffic jam ahead in the predicted route 170. The schedule-altering event 182 (e.g. snow showers) may have been detected by the detection module 133 via receiving, retrieving, or otherwise obtaining information/data from one or more data sources, such as a weather application server 112, a vehicle-to-vehicle communication network transmitted by the input mechanism 111a associated with the first user, such as a vehicle, and/or other users' mobile devices connected to the computing system 120 that may be reporting real-time GPS information while located in the storm ahead in the predicted route 170. Thus, embodiments of the detection module 133 may communicate with third party application servers 112 and other data sources to detect a schedule-altering event 181, 182 along the predicted route 170.

In response to the detection of the schedule-altering events 181, 182 along a predicted route 170 of the first user, the current estimated arrival time of the first user may be updated. For instance, the computing devices associated with the destination 165 may receive updates from the computing system 120 to alert the representatives, associates, employees, etc. of the destination 165 of the new estimated arrival time of the first user. In some embodiments, the newly updated estimated arrival time may still be sooner than a current estimated arrival time of the second user, and thus no queue priority adjustment is needed. In other embodiments, the newly updated estimated arrival time may now be later than the current estimated arrival time of the second user, wherein a queue priority adjustment may be performed.

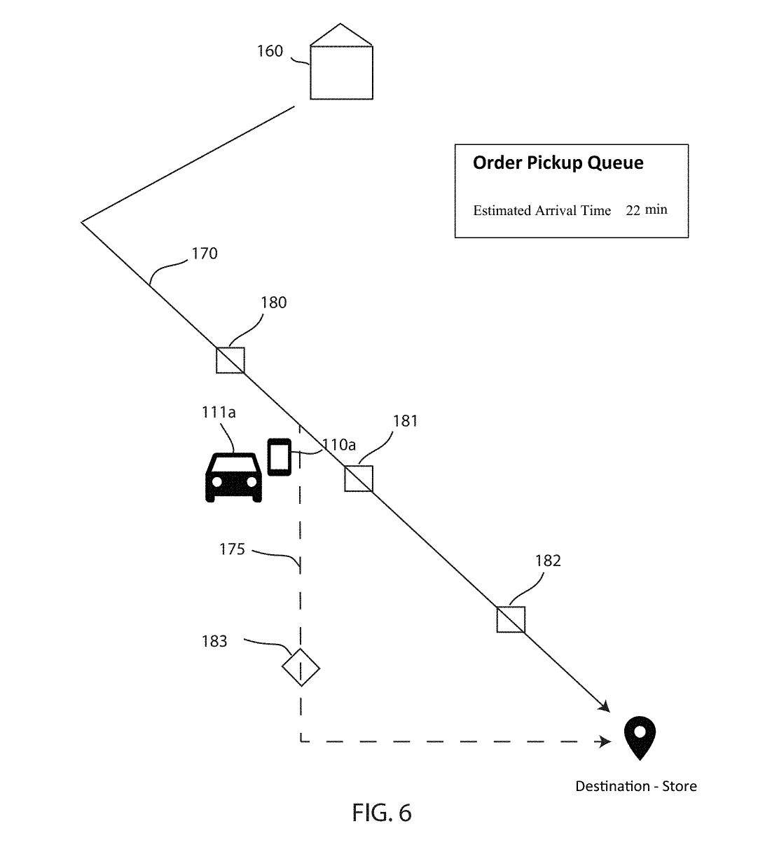

FIG. 6 depicts a schematic view of a new predicted route 175 and estimated time of arrival of the first user from a fourth current location, in accordance with embodiments of the present invention. In FIG. 6, the arrival time module 131 has determined that the current estimated arrival time for the first user is now 22 minutes, and the prediction module 132 has predicted or otherwise determined that the most likely route the user will take to get to the destination 165, is a new predicted route 175. The new predicted route 175 may be determined by the prediction module 132, in response to receiving GPS location information from the user device 110a and/or input mechanism 111a. In some embodiments, computing system 120 may send an alert to the first user of the upcoming, detected schedule-altering events 181, 182, which may prompt the first user to take an alternate route. The alternate route is then predicted to be the new predicted route 175 to the destination 165. In other embodiments, the user may have made a wrong turn or voluntarily decided to take a new path to the destination 165. In either event, the prediction module 132 may utilize information/data received to predict or otherwise project a new predicted route 175. As the first user is in transit (i.e. has departed from a home location or initial location and has changed paths to the destination from predicted route 170 to new predicted route 175), the detection module 133 has detected, predicted, or otherwise identified a schedule-altering event 183 along the new predicted route 175. For example, the detection module 133 has detected heavy traffic along the new predicted route 175, which the first user will encounter if the first user continues along the new predicted route 175. The schedule-altering event 183 (e.g. heavy traffic) may have been detected by the detection module 133 via receiving, retrieving, or otherwise obtaining information/data from one or more data sources, such as a traffic application server 112, a vehicle-to-vehicle communication network transmitted by the input mechanism 111a associated with the first user, such as a vehicle, a navigation application server 112, and/or other users' mobile devices connected to the computing system 120 that may be reporting real-time GPS information while located in the traffic jam ahead in the new predicted route 175. Thus, embodiments of the detection module 133 may communicate with third party application servers 112 and other data sources to detect a schedule-altering event 183 along the new predicted route 175.

In response to the detection of the schedule-altering event 183 along a new predicted route 175 of the first user, the current estimated arrival time of the first user may be updated. For instance, the computing devices associated with the destination 165 may receive updates from the computing system 120 to alert the representatives, associates, employees, etc. of the destination 165 of the new estimated arrival time of the first user. In some embodiments, the newly updated estimated arrival time may still be sooner than a current estimated arrival time of the second user, and thus no queue priority adjustment is needed. In other embodiments, the newly updated estimated arrival time may now be later than the current estimated arrival time of the second user, wherein a queue priority adjustment may be performed.

Moreover, embodiments of the detection module 133 may detect the schedule-altering event by analyzing a current state of a vehicle. For example, the detection module 133 may analyze data/information provided by the input mechanism 111a, such as a vehicle computing system of a vehicle operated by the first user. Embodiments of the vehicle computing system may be an onboard computer of the vehicle, which may collect information from a plurality of sensors associated with the vehicle, and transmit the information/data to the computing system 120. In an exemplary embodiment, the input mechanism 111a may transmit vehicle speed, which may affect the first user's estimated time of arrival. Further, a GPS location information from a user device 110a may also be transmitted to detect a vehicle speed, or other state of the vehicle. The vehicle computing network may also transmit information regarding a vehicle failure, a damage to the vehicle, an engine status, a maintenance issue of the vehicle, and the like. For example, the detection module 133 may detect a vehicle failure that can affect the first user's estimated arrival time, or that the user has turned off the engine to the vehicle to stop for coffee before arriving at the destination 165. Thus, a state of the vehicle may be reported and/or monitored by the detection module 133 to detect a potential schedule-altering event resulting from a state of the vehicle. This information/data may also be used to constantly update the estimated time of arrival of the user. Embodiments of the state of the vehicle may include engine off, engine on, low tire pressure, engine running but no motion, stopped, accelerating, moving, damage to one or more components, whether an anti-braking system is activated, whether an adaptive or conventional cruise control is activated, and the like.

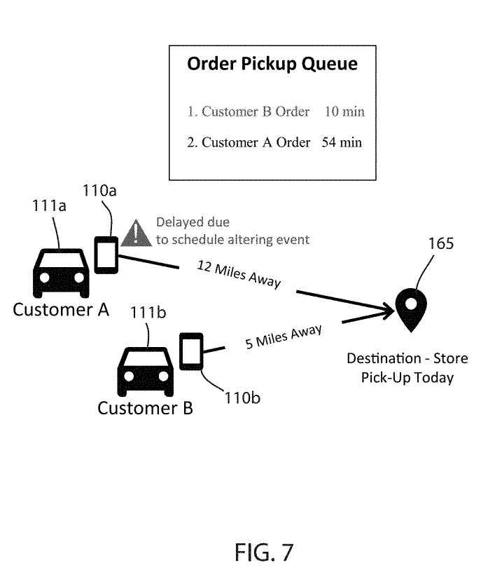

FIG. 7 depicts a schematic view of a schedule-altering event of the first user, in accordance with embodiments of the present invention. In FIG. 7, the detection module 133 has detected a schedule-altering event of the first user, in response to receiving data from the input mechanism 111a that the first user's vehicle has been in a minor traffic accident. One or more sensors of the input mechanism 111a may transmit information pertaining to a vehicle collision, damage, etc. to the computing system 120 to suggest that the first user has been in a minor traffic accident. In response to the detection of the schedule-altering event based on a state of the vehicle, the current estimated arrival time of the first user may be updated. For instance, the computing devices associated with the destination 165 may receive updates from the computing system 120 to alert the representatives, associates, employees, etc. of the destination 165 of the new estimated arrival time of the first user. In some embodiments, the newly updated estimated arrival time may still be sooner than a current estimated arrival time of the second user, and thus no queue priority adjustment is needed. In other embodiments, the newly updated estimated arrival time may now be later than the current estimated arrival time of the second user, wherein a queue priority adjustment may be performed.

Embodiments of the detection module 133 may analyze both the predicted route 170, 175 and a state of the vehicle to detect one or more schedule-altering events 180, 181, 182, 183. In an exemplary embodiment, the detection module 133 may cross-reference information/data from the plurality of data sources to confirm an existence of a schedule-altering event. For example, the detection module 133 may receive data from a weather service application server 112 suggesting a thunderstorm will be developing along the predicted route 170 at a certain time that the first user is predicted to be traveling along the predicted route 170. The detection module 133 may receive data from a humidity sensor and/or temperature data of the vehicle to confirm that the environmental conditions are likely to produce a thunderstorm. In a further example, the detection module 133 may receive data regarding an impending traffic jam by analyzing the predicted route 170, but may also detect that the vehicle operated by the first user is braking and/or reducing an average speed, as well as GPS location information received from the user device 110a that indicates that the first user is traveling at a slower speed.

Accordingly, embodiments of the computing system 120 may effectively detect schedule-altering events and perform real-time updating of a user's estimated arrival time. Instead of using a single source of data, such as GPS information from a mobile device, the computing system 120 may receive and analyze data from a plurality of sources pertaining to a state of a vehicle and/or a predicted route of the user. For instance, detecting a traffic jam a distance further down a predicted route of the user may allow the computing system 120 to update the estimated arrival time well before the first user reaches the location of the traffic jam, in which case if only the GPS location information was being analyzed from the user's mobile device, the information would be reporting that everything is on time and no updating of the estimated arrival time would occur. In other words, the GPS-only information may only be useful to report a current location, and any updating of the estimated arrival times will not occur until the user is actually located in the traffic jam, for example.

Referring back to FIG. 1, and with continued reference to FIG. 7, embodiments of the computing system 120 may include a prioritization module 134. Embodiments of the prioritization module 134 may include one or more components of hardware and/or software program code for reprioritizing the queue priority database. For instance, the prioritization module 134 may adjust a queue priority in a queue priority database 114, based on the updated estimated arrival time of the first user and the second user. Embodiments of the prioritization module 134 may calculate an updated queue priority of the first user as the estimated times of arrival are updating based on a detection of a schedule-altering event. If the calculated queue priority of the first user is lower than the queue priority of the second user, based on the detection of the schedule-altering event of the first user and updated times of arrival for the first user and the second user, the prioritization module 134 may adjust the queue priority database 114 so that the second user is accommodated prior to the first user. As shown in FIG. 7, the estimated arrival time for the first user is now later than the estimated arrival time of the second user. Accordingly, embodiments of the prioritization module 134 may adjust a queue priority of the queue priority database 114 so that the second user has a higher queue priority than the first user.

Various tasks and specific functions of the modules of the computing system 120 may be performed by additional modules, or may be combined into other module(s) to reduce the number of modules. Further, embodiments of the computer or computer system 120 may comprise specialized, non-generic hardware and circuitry (i.e., specialized discrete non-generic analog, digital, and logic-based circuitry) (independently or in combination) particularized for executing only methods of the present invention. The specialized discrete non-generic analog, digital, and logic-based circuitry may include proprietary specially designed components (e.g., a specialized integrated circuit, such as for example an Application Specific Integrated Circuit (ASIC), designed for only implementing methods of the present invention). Moreover, embodiments of the queue prioritization system 100 may improve computer technology, whereby utilizing plurality of hardware data sources to predict a route that a user may take to a destination and continuously analyzing/predicting/detecting schedule-altering events along a predicted route and analyzing vehicle information and data from third party application servers to determine a realistic time of arrival to maintain a queue priority database.

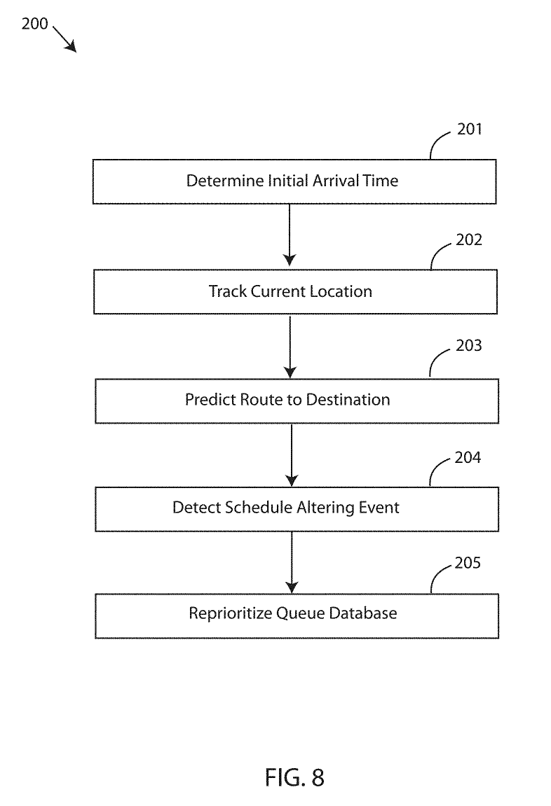

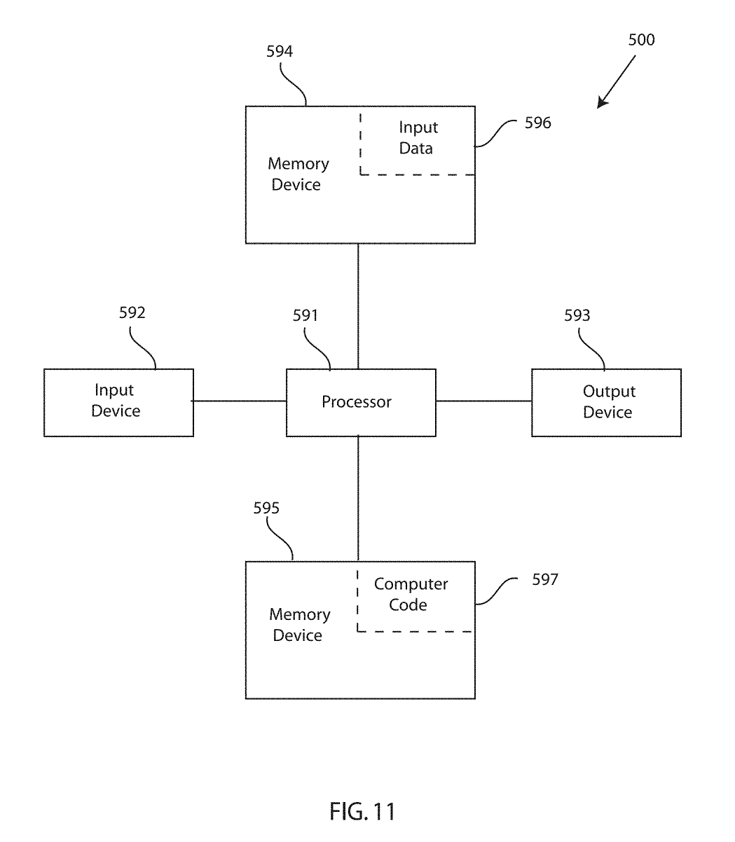

Referring now to FIG. 8, which depicts a flow chart of a method for predicting a realistic time of arrival for performing a queue priority adjustment, in accordance with embodiments of the present invention. One embodiment of a method 200 or algorithm that may be implemented for predicting a realistic time of arrival for performing a queue priority adjustment in accordance with the queue prioritization system 100 described in FIGS. 1-7 using one or more computer systems as defined generically in FIG. 11 below, and more specifically by the specific embodiments of FIG. 1.

Embodiments of the method 200 for predicting a realistic time of arrival for performing a queue priority adjustment, in accordance with embodiments of the present invention, may begin at step 201 wherein an initial arrival time is determined. For example, an initial estimated arrival time for each user associated with the queue prioritization system 100 may be determined. For example, an initial estimated arrival time of a drone to deliver a package may be determined, an initial estimated arrival time of a delivery truck to arrive at a receiving area may be determined, and an initial estimated customer arrival time for a pickup order may be determined. Step 202 tracks a current location of the one or more users associated with system 100. Step 203 predicts a route to a destination, based on a plurality of data sources, as described above. Step 204 detects a schedule-altering event of one or more users associated with the system 100.

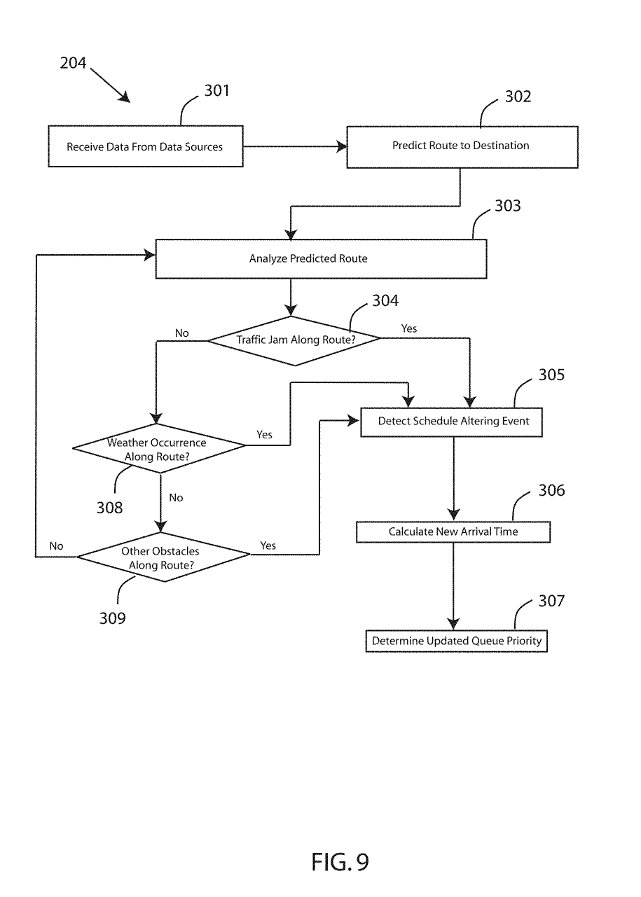

FIG. 9 depicts a first flow chart of a step 204 of the method 200 for predicting a realistic time of arrival for performing a queue priority adjustment of FIG. 8, in accordance with embodiments of the present invention. For instance, step 204 of detecting a schedule-altering event may include various steps associated with analyzing a predicted route of the user for one or more schedule-altering events. Step 301 receives data from one or more data sources. Step 302 predicts a likely route to be taken by the user to the destination. Step 303 analyzes the predicted route. Step 304 determines whether a schedule-altering event is expected or detected on or along the predicted route of the user to the destination. For example, step 304 determines whether any traffic jams are occurring or are predicted to occur along the predicted route. If yes, then step 305 detects a schedule-altering event, and step 306 calculates a new arrival time. Step 307 determines the updated queue priority. If no traffic jam is detected, then step 308 determines whether a schedule-altering event is expected or detected on or along the predicted route of the user to the destination. For example, step 308 determines whether any weather issues (e.g. storms) are occurring or are predicted to occur along the predicted route. If yes, then step 305 detects a schedule-altering event, and step 306 calculates a new arrival time. Step 307 determines the updated queue priority. If no weather occurrence is detected, then step 309 determines whether a schedule-altering event is expected or detected on or along the predicted route of the user to the destination. For example, step 309 determines whether any other obstacles (e.g. construction, heavy traffic, accidents, detours, emergency vehicles, etc.) are occurring or are predicted to occur along the predicted route. If yes, then step 305 detects a schedule-altering event, and step 306 calculates a new arrival time. Step 307 determines the updated queue priority. If no schedule-altering event is detected, then the method returns to step 303 for continued analysis of the predicted route of the user. Further, after step 307 determines the updated queue priority, then the method continues to step 205 of method 200, shown in FIG. 8.

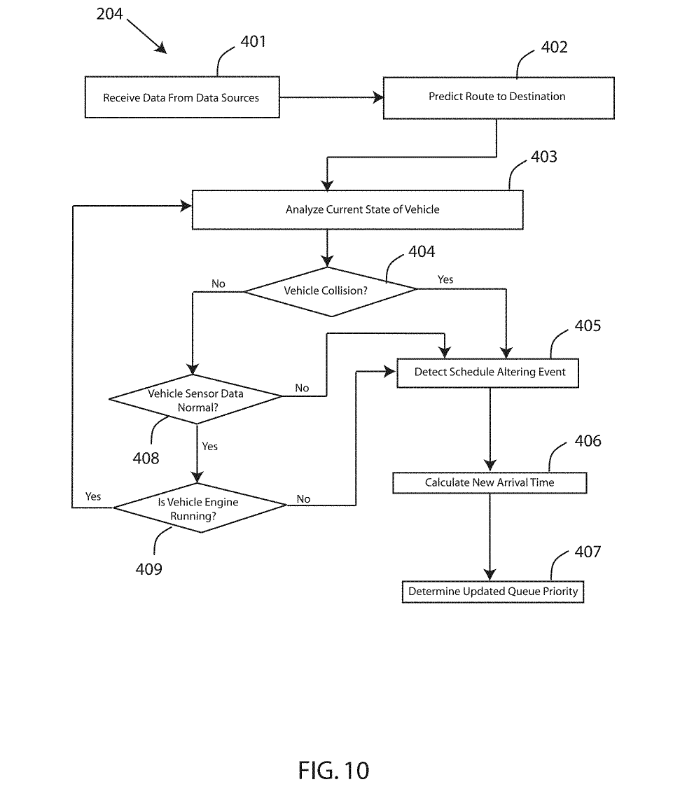

FIG. 10 depicts a second flow chart of a step 204 of the method 200 for predicting a realistic time of arrival for performing a queue priority adjustment of FIG. 8, in accordance with embodiments of the present invention. For instance, step 204 of detecting a schedule-altering event may include various steps associated with analyzing a current state of a vehicle for one or more schedule-altering events. Step 401 receives data from one or more data sources. Step 402 predicts a likely route to be taken by the user to the destination. Step 403 analyzes the current state of the vehicle. Step 404 determines whether a schedule-altering event is expected or detected based on a status of the vehicle. For example, step 404 determines whether a vehicle collision has occurred. If yes, then step 405 detects a schedule-altering event, and step 406 calculates a new arrival time. Step 407 determines the updated queue priority. If no vehicle collision is detected, then step 408 determines whether a schedule-altering event is expected or detected based on a status of the vehicle. For example, step 408 determines whether vehicle sensor data is normal. If no, then step 405 detects a schedule-altering event, and step 406 calculates a new arrival time. Step 407 determines the updated queue priority. If the sensor data is normal, then step 409 determines whether a schedule-altering event is expected or detected based on a status of the vehicle. For example, step 409 determines whether the vehicle's engine is running, which may help determine if the user has made a stop during transit to the destination. If no then step 405 detects a schedule-altering event, and step 406 calculates a new arrival time. Step 407 determines the updated queue priority. If no schedule-altering event is detected, then the method returns to step 403 for continued analysis of the state of the vehicle. Further, after step 407 determines the updated queue priority, then the method continues to step 205 of method 200, shown in FIG. 8.

Referring back to FIG. 8, step 205 determines whether the updated queue priority requires a reprioritization of the queue priority database. If so, then step 205 reprioritizes the queue priority database accordingly.

FIG. 11 illustrates a block diagram of a computer system for the queue prioritization system of FIGS. 1-7, capable of implementing methods for predicting a realistic time of arrival for performing a queue priority adjustment of FIGS. 8-10, in accordance with embodiments of the present invention. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer 500, including executing instructions included in the computer code 597 for the tools and programs capable of implementing a method for predicting a realistic time of arrival for performing a queue priority adjustment, in the manner prescribed by the embodiments of FIGS. 8-10 using the queue prioritization system 100 of FIGS. 1-7, wherein the instructions of the computer code 597 may be executed by processor 591 via memory device 595. The computer code 597 may include software or program instructions that may implement one or more algorithms for implementing the methods for predicting a realistic time of arrival for performing a queue priority adjustment, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer-readable program embodied therein and/or having other data stored therein, wherein the computer-readable program comprises the computer code 597. Generally, a computer program product (or, alternatively, an article of manufacture) of the computer system 500 may comprise said computer usable storage medium (or said program storage device).

Memory devices 594, 595 include any known computer-readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 11.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, etc. or in some embodiments the touchscreen of a mobile device. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository 125 as shown in FIG. 1.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to queue prioritization systems and methods. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer 500) including one or more processor(s) 591, wherein the processor(s) carry out instructions contained in the computer code 597 causing the computer system to predict a realistic time of arrival for performing a queue priority adjustment. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method for predicting a realistic time of arrival for performing a queue priority adjustment. Thus, the present invention discloses a process for supporting, deploying and/or integrating computer infrastructure, integrating, hosting, maintaining, and deploying computer-readable code into the computer system 500, wherein the code in combination with the computer system 500 is capable of performing a method for predicting a realistic time of arrival for performing a queue priority adjustment.

A computer program product of the present invention comprises one or more computer-readable hardware storage devices having computer-readable program code stored therein, said program code containing instructions executable by one or more processors of a computer system to implement the methods of the present invention.

A computer system of the present invention comprises one or more processors, one or more memories, and one or more computer-readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein

1. A method for predicting a realistic time of arrival for performing a queue priority adjustment, the method comprising:
determining, by a processor of a computing system, an estimated initial arrival time of a first user and a second user to a destination, the estimated initial arrival time being used to establish a queue priority of the first user and a queue priority of the second user, in a queue priority database, the queue priority of the first user being higher than the queue priority of the second user;
tracking, by the processor, a current location of the first user and a current location of the second user, during transit to the destination;
predicting, by the processor, a route to be taken to arrive at the destination from the current location of the first user and the current location of the second user, respectively;
detecting, by the processor, a schedule-altering event of the first user by analyzing: (i) the predicted route of the first user, or (ii) a current state of a vehicle; and
reprioritizing, by the processor, the queue priority database, in response to calculating an updated queue priority of the first user that is lower than the queue priority of the second user, based on the detection of the schedule-altering event of the first user.

2. The method of claim 1, wherein determining the estimated initial arrival time of the first user and the second user includes:
receiving, by the processor, a customer pick-up order and current GPS location information of the first user and the second user, the GPS location information obtained from a mobile device of the first user and the second user;
reviewing, by the processor, historical user data, including a historical path taken by the first user and the second user to the destination;
evaluating, by the processor, a complexity of the customer pick-up order to determine an earliest store pick-up time; and
comparing, by the processor, the earliest store pick-up time, the current GPS location of the first user and the second user, and the historical path taken by the first user and the second user to the destination, to determine the estimated initial arrival time, in response to: (i) prompting the first user and the second user to depart for the destination, or (ii) receiving confirmation from the first user and the second user that the first user and the second user have departed for the destination.

3. The method of claim 2, wherein prompting the first user and the second user to depart for the destination includes providing, by the processor, a suggested departure time based on at least one of: the earliest store pick-up time, current traffic conditions, current location of the first user and the second user, and historical traffic patterns of the first user and the second user.

4. The method of claim 1, wherein determining the estimated initial arrival time includes:
receiving, by the processor, scheduled delivery information and current GPS location information of the first user and the second user;
reviewing, by the processor, historical delivery pattern data, based on previous deliveries to the destination;
evaluating, by the processor, the scheduled delivery information, the current GPS location information of the first user and the second user, and the historical delivery pattern data, to determine an earliest delivery arrival time.

5. The method of claim 1, wherein the detecting of the schedule-altering event includes receiving data from a plurality of data sources, the plurality of data sources including a current GPS location of the user received from a mobile device of the user, a real-time traffic data received from the mobile device of the user, a real-time traffic data received from a third party application server, a weather data received from the mobile device of the user, a weather data retrieved from a third party application server, a historical traffic pattern information of the user, a sensor data received from one or more sensors associated with the user, a vehicle and traffic information received from a vehicle-to-vehicle communication network, and a combination thereof.

6. The method of claim 1, wherein the schedule-altering event is at least one of: a delay, a traffic jam, a traffic accident, a vehicle failure, a weather occurrence, an intervening stop by the first user, a wrong turn of the user, an alternative route taken by the user, a predicted traffic delay of the first user, and a predicted weather delay of the first user.

7. The method of claim 1, wherein predicting the route of the first user includes analyzing the current location of the first user, current traffic data, construction data, historical routes to the destination taken by the first user, and map data.

8. The method of claim 1, wherein reprioritizing the queue priority database causes: (i) an in-store pickup order associated with the second user to be available for pickup when the second user arrives at the destination, and before an in-store pickup order associated with the first user is available for pickup, or (ii) a delivery vehicle operated by the first user to be assigned to an available unloading location at the destination, when the first user arrives at the destination.

9. The method of claim 1, wherein the first user and the second user is a customer, a delivery truck driver, an autonomous vehicle, or an unmanned drone.

10. A computer system, comprising:
a processor;
a memory device coupled to the processor; and
a computer-readable storage device coupled to the processor, wherein the storage device contains program code executable by the processor via the memory device to implement a method for predicting a realistic time of arrival for performing a queue priority adjustment, the method comprising:
determining, by a processor of a computing system, an estimated initial arrival time of a first user and a second user to a destination, the estimated initial arrival time being used to establish a queue priority of the first user and a queue priority of the second user, in a queue priority database, the queue priority of the first user being higher than the queue priority of the second user;
tracking, by the processor, a current location of the first user and a current location of the second user, during transit to the destination;
predicting, by the processor, a route to be taken to arrive at the destination from the current location of the first user and the current location of the second user, respectively;
detecting, by the processor, a schedule-altering event of the first user by analyzing: (i) the predicted route of the first user, or (ii) a current state of a vehicle; and
reprioritizing, by the processor, the queue priority database, in response to calculating an updated queue priority of the first user that is lower than the queue priority of the second user, based on the detection of the schedule-altering event of the first user.

11. The computer system of claim 10, wherein determining the estimated initial arrival time of the first user and the second user includes:
receiving, by the processor, a customer pick-up order and current GPS location information of the first user and the second user, the GPS location information obtained from a mobile device of the first user and the second user;
reviewing, by the processor, historical user data, including a historical path taken by the first user and the second user to the destination;
evaluating, by the processor, a complexity of the customer pick-up order to determine an earliest store pick-up time; and
comparing, by the processor, the earliest store pick-up time, the current GPS location of the first user and the second user, and the historical path taken by the first user and the second user to the destination, to determine the estimated initial arrival time, in response to: (i) prompting the first user and the second user to depart for the destination, or (ii) receiving confirmation from the first user and the second user that the first user and the second user have departed for the destination.

12. The computer system of claim 11, wherein prompting the first user and the second user to depart for the destination includes providing, by the processor, a suggested departure time based on at least one of: the earliest store pick-up time, current traffic conditions, current location of the first user and the second user, and historical traffic patterns of the first user and the second user.

13. The computer system of claim 10, wherein determining the estimated initial arrival time includes:
receiving, by the processor, a scheduled delivery information and a current GPS location information of the first user and the second user;
reviewing, by the processor, a historical delivery pattern data, based on previous deliveries to the destination;
evaluating, by the processor, the scheduled delivery information, the current GPS location information of the first user and the second user, and the historical delivery pattern data, to determine an earliest delivery arrival time.

14. The computer system of claim 10, wherein the detecting of the schedule-altering event includes receiving data from a plurality of data sources, the plurality of data sources including a current GPS location of the user received from a mobile device of the user, a real-time traffic data received from the mobile device of the user, a real-time traffic data received from a third party application server, a weather data received from the mobile device of the user, a weather data retrieved from a third party application server, a historical traffic pattern information of the user, a sensor data received from one or more sensors associated with the user, a vehicle and traffic information received from a vehicle-to-vehicle communication network, and a combination thereof.

15. The computer system of claim 10, wherein the schedule-altering event is at least one of: a delay, a traffic jam, a traffic accident, a vehicle failure, a weather occurrence, an intervening stop by the first user, a wrong turn of the user, an alternative route taken by the user, a predicted traffic delay of the first user, and a predicted weather delay of the first user.

16. The computer system of claim 10, wherein predicting the route of the first user includes analyzing the current location of the first user, current traffic data, construction data, historical routes to the destination taken by the first user, and map data.

17. The computer system of claim 10, wherein reprioritizing the queue priority database causes: (i) an in-store pickup order associated with the second user to be available for pickup when the second user arrives at the destination, and before an in-store pickup order associated with the first user is available for pickup, or (ii) a delivery vehicle operated by the first user to be assigned to an available unloading location at the destination, when the first user arrives at the destination.

18. The computer system of claim 10, wherein the first user and the second user is a customer, a delivery truck driver, an autonomous vehicle, or an unmanned drone.

19. A computer program product, comprising a computer-readable hardware storage device storing a computer-readable program code, the computer-readable program code comprising an algorithm that when executed by a computer processor of a computing system implements a method for predicting a realistic time of arrival for performing a queue priority adjustment, the method comprising:
determining, by a processor of a computing system, an estimated initial arrival time of a first user and a second user to a destination, the estimated initial arrival time being used to establish a queue priority of the first user and a queue priority of the second user, in a queue priority database, the queue priority of the first user being higher than the queue priority of the second user;
tracking, by the processor, a current location of the first user and a current location of the second user, during transit to the destination;
predicting, by the processor, a route to be taken to arrive at the destination from the current location of the first user and the current location of the second user, respectively;
detecting, by the processor, a schedule-altering event of the first user by analyzing: (i) the predicted route of the first user, or (ii) a current state of a vehicle; and
reprioritizing, by the processor, the queue priority database, in response to calculating an updated queue priority of the first user that is lower than the queue priority of the second user, based on the detection of the schedule-altering event of the first user.

20. The computer program product of claim 19, wherein determining the estimated initial arrival time of the first user and the second user includes:
receiving, by the processor, a customer pick-up order and a current GPS location information of the first user and the second user, the GPS location information obtained from a mobile device of the first user and the second user;
reviewing, by the processor, historical user data, including a historical path taken by the first user and the second user to the destination;
evaluating, by the processor, a complexity of the customer pick-up order to determine an earliest store pick-up time; and
comparing, by the processor, the earliest store pick-up time, the current GPS location of the first user and the second user, and the historical path taken by the first user and the second user to the destination, to determine the estimated initial arrival time, in response to: (i) prompting the first user and the second user to depart for the destination, or (ii) receiving confirmation from the first user and the second user that the first user and the second user have departed for the destination.

21. The computer program product of claim 20, wherein prompting the first user and the second user to depart for the destination includes providing, by the processor, a suggested departure time based on at least one of: the earliest store pick-up time, current traffic conditions, current location of the first user and the second user, and historical traffic patterns of the first user and the second user.

22. The computer program product of claim 19, wherein determining the estimated initial arrival time includes:
receiving, by the processor, a scheduled delivery information and current GPS location information of the first user and the second user;
reviewing, by the processor, a historical delivery pattern data, based on previous deliveries to the destination; and
evaluating, by the processor, the scheduled delivery information, the current GPS location information of the first user and the second user, and the historical delivery pattern data, to determine an earliest delivery arrival time.

23. The computer program product of claim 19, wherein the detecting of the schedule-altering event includes receiving data from a plurality of data sources, the plurality of data sources including a current GPS location of the user received from a mobile device of the user, a real-time traffic data received from the mobile device of the user, a real-time traffic data received from a third party application server, a weather data received from the mobile device of the user, a weather data retrieved from a third party application server, a historical traffic pattern information of the user, a sensor data received from one or more sensors associated with the user, a vehicle and traffic information received from a vehicle-to-vehicle communication network, and a combination thereof.

24. The computer program product of claim 19, wherein the schedule-altering event is at least one of: a delay, a traffic jam, a traffic accident, a vehicle failure, a weather occurrence, an intervening stop by the first user, a wrong turn of the user, an alternative route taken by the user, a predicted traffic delay of the first user, and a predicted weather delay of the first user.

25. The computer program product of claim 19, wherein predicting the route of the first user includes analyzing the current location of the first user, current traffic data, construction data, historical routes to the destination taken by the first user, and map data.

26. The computer program product of claim 19, wherein reprioritizing the queue priority database causes: (i) an in-store pickup order associated with the second user to be available for pickup when the second user arrives at the destination, and before an in-store pickup order associated with the first user is available for pickup, or (ii) a delivery vehicle operated by the first user to be assigned to an available unloading location at the destination, when the first user arrives at the destination.

27. The computer program product of claim 19, wherein the first user and the second user is a customer, a delivery truck driver, an autonomous vehicle, or an unmanned drone.
